(19) United States
(12) Patent Application Publication
(10) Pub. No.: US 2015/0176327 A1
(43) Pub. Date: Jun. 25, 2015

(54) Green Windows System

(71) Applicant: Green Winows Corp., Bayamón, PR (US)

(72) Inventor: Carlos Goyco-Graziani, Guanica, PR (US)

(21) Appl. No.: 14/577,637

(22) Filed: Dec. 19, 2014

Related U.S. Application Data
(60) Provisional application No. 61/917,955, filed on Dec. 19, 2013.

(51) Int. Cl. E06B 7/086; E06B 3/263; E06B 3/08; E04F 10/08; E06B 7/096

(52) U.S. Cl. CPC E06B 7/086; E04F 10/08; E06B 7/096; E06B 3/08; E06B 3/263

(57) ABSTRACT

A window especially suitable for active protection comprised of security bars integrated into the slats, reinforced anchors, monobloc laminated glass, and an automatic or manual operating shifter. The operating shifter comprises a window opening assisting mechanism that provides additional security while making it possible to operate the window in a stress-free, effortless fashion.

### RELATED APPLICATIONS

This application claims the benefit of U.S. Provisional Application No. 61/917,955 filed Dec. 19, 2013, which is hereby incorporated by reference in its entirety.

### BACKGROUND OF THE DISCLOSURE

1. Field of the Invention

The present invention relates to a system and method for improved louver windows, and specifically to improved manufacture and efficiency processes of said assemblies.

2. Description of the Related Art

In response to the high levels of crime, economic, environment and energy crises, there is a clear need to create products that address them. It is imperative to address public, schools, universities, hospitals, shopping malls and other safety against terrorist attack by internal and external means. The above must be done while taking into account how indiscriminate residential and product entrapment installation of railings may obstruct emergency exits during events such as floods or fire. The challenge is product development capable of protecting human beings and injecting into the economy new jobs while improving our quality of life.

One such area for product development is dwelling windows. These require a window product that has stylized appearance combined with a conservative classic elegant look that blends into the landscape providing a sense of freedom, but at the same time incorporates the essential safety feature against theft, vandalism, tornadoes, hurricanes, sound, and other issues while placing energy disadvantages at the forefront of their beneficiaries.

### SUMMARY OF THE INVENTION

This section is for the purpose of summarizing some aspects of the present invention and to briefly introduce some preferred embodiments. Simplifications or omissions may be made to avoid obscuring the purpose of the section. Such simplifications or omissions are not intended to limit the scope of the present invention.

All references, including any patents or patent applications cited in this specification are hereby incorporated by reference. No admission is made that any reference constitutes prior art. The discussion of the references states what their authors assert, and the applicants reserve the right to challenge the accuracy and pertinence of the cited documents. It will be clearly understood that, although a number of prior art publications are referred to herein, this reference does not constitute an admission that any of these documents form part of the common general knowledge in the art.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

In one aspect the invention is about an apparatus comprising one or more monobloc glass louvers, one or more cromoly bars, and an integrated operator shifter comprised of a compact assembly. In more detail, the invention is about a window frame having upper, lower, left and right walls, a plurality of cromoly bars for increased security, a plurality of louvers extending from the left wall to the right wall of the window frame, the plurality of louvers being rotatable about a parallel axis, a drive coupling extending from at least one side of each of the plurality of louvers so as to allow synchronous rotation of the plurality of louvers about the parallel axis, an operating bar within at least one the left wall or right wall of the window frame, the operating bar being connected with the drive coupling in each of the plurality of louvers and, an operator shifter comprising a window opening assisting mechanism coupled to the operating bar, said assisting mechanism providing an angular displacement with respect to the operating bar, a distant holder coupled to the operating bar, a biasing device having an upper and a lower side, the upper and lower side of the biasing device operatively coupled to the assisting mechanism and the distant holder, respectively, and, a handle bar operatively coupled to the operating bar.

Other features and advantages of the present invention will become apparent upon examining the following detailed description of an embodiment thereof, taken in conjunction with the attached drawings.

### BRIEF DESCRIPTION OF THE DRAWINGS

FIGS. 1-6 show illustrations of the window system including its operator shifter.

FIGS. 7-12 show illustrations of the monobloc glass laminated louvers.

FIGS. 13-18 show illustrations of the thermal honey comb brake.

FIG. 19 shows a sectional illustration of a window bonding system.

FIG. 20 illustrates reinforced side anchors parallel to the pivot point of the louvers.

FIGS. 21-22 show the crystal guidance within the louvers necessary for impact resistance.

The above-described and other features will be appreciated and understood by those skilled in the art from the following detailed description, drawings, and appended claims.

### DETAILED DESCRIPTION OF THE PREFERRED EMBODIMENT

To provide an overall understanding of the invention, certain illustrative embodiments and examples will now be described. However, it will be understood by one of ordinary skill in the art that the same or equivalent functions and sequences may be accomplished by different embodiments that are also intended to be encompassed within the spirit and scope of the disclosure. The compositions, apparatuses, systems and/or methods described herein may be adapted and modified as is appropriate for the application being addressed and that those described herein may be employed in other suitable applications, and that such other additions and modifications will not depart from the scope hereof.

As used in the specification and claims, the singular forms “a”, “an” and “the” include plural references unless the context clearly dictates otherwise. For example, the term “a transaction” may include a plurality of transaction unless the context clearly dictates otherwise. As used in the specification and claims, singular names or types referenced include variations within the family of said name unless the context clearly dictates otherwise.

Certain terminology is used in the following description for convenience only and is not limiting. The words “lower,” “upper,” “bottom,” “top,” “front,” “back,” “left,” “right” and “sides” designate directions in the drawings to which reference is made, but are not limiting with respect to the orientation in which the modules or any assembly of them may be used.

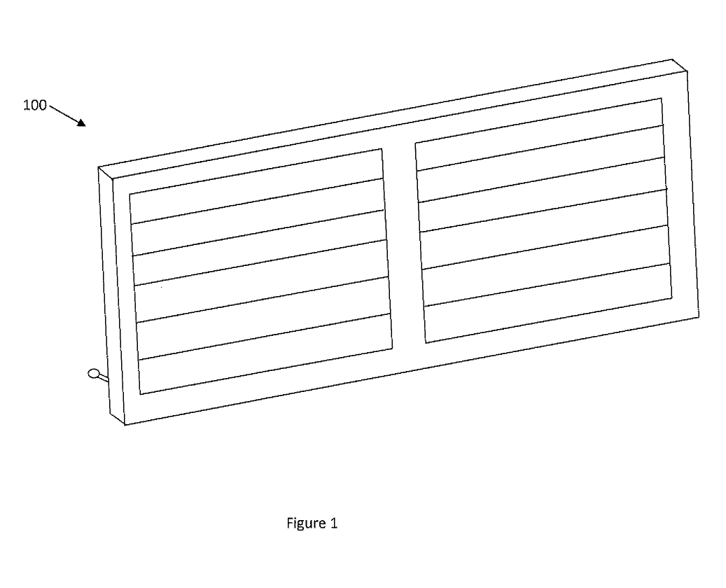

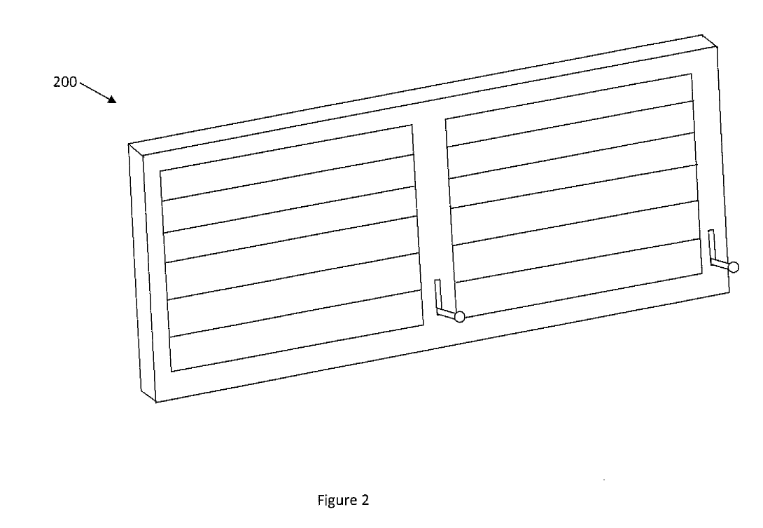

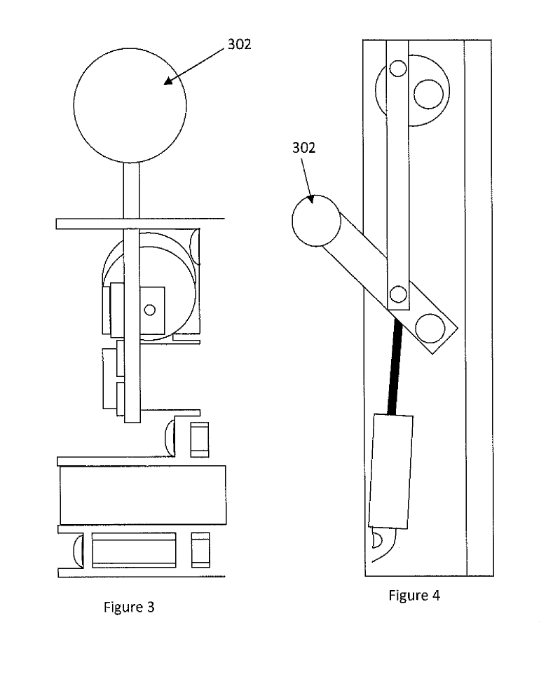

Referring to FIGS. 1-6 we see one embodiment, of the Green Windows Shield front 100 and back 200 views of a new system with an integrated operator shifter 302 having a compact, efficient and convenient system that reduces the effort, time in operation and being virtually unbreakable. Such a system operates without additional moving mechanical parts, which allows us to take advantage of natural leverage point mechanism reducing the force required for operation without increasing the length of the lever. One of the additional attributes of said integrated shifter 302 is its low projection having little or no interference.

In an alternate embodiment, the equipment may have simultaneous optional manual or automatic operation. The point of rotation of the blade where it is commonly installed connects said rod synchronous bar (operating bar), so the rod is designed to flush the window frame itself and hence this bar will be connected to a handle to move outside the frame (operator handle). The lever will have fixed teeth that will determine the desired position of the slats when opening the window.

In one embodiment, a spring connected to the synchro bar will neutralize the weight of the slats further, reducing the operating force required which is an ADA recommendation when the system is used by persons with disabilities. The spring is coupled with a window opening assisting mechanism having an angular displacement that shifts the linear force exerted by the spring on the operating bar. When the window is fully closed, the spring's tension aids in keeping the slats sealed and serves as a security feature. When the slats are open, the assisting mechanism shifts the force exerted by the spring's tension and serves to equalize the weight of the slats so as to ensure that they are not forcefully closed by an external force. It will be understood that the assisting mechanism is coupled to the spring in such a way that the spring's maximal force is used to seal the slats when the window is closed. When the assisting mechanism displaces angularly, the spring adjusts its tension to equalize the weight of the slats while the assisting mechanism causes the exerting force to shift in the opposite direction, therefore keeping the windows open. In yet another embodiment, simultaneous operation manually, automatically or semi-automatically (i.e. hybrid) would allow a hybrid configuration that provides both options manually or automatically fully to be effective in unison.

In an alternate embodiment, security bars (say made of Chromoly) could be integrated between the slats. Such a configuration would allow for the gradual raise of the security level to be added to bars that run into each other exercising a maximum of three increasing structural rigidity and the type of security (i.e. security jail bar). A Chromoly bar is integrated in the blade holder as a thermodynamic process which reduces the space, weight, cost, time and parts resulting in a reduction of 50% aluminum per assembly. Such a process solves the problem of reaction between different materials and increases the lifetime of the extrusion die of the blade holder bar.

Potentially, it would also have progressive assembly bars which are fixed with a polycarbonate shutters that could be kept on-site and allows bars to rotate freely inside each other resulting in the type of security (security jail bar) better known as an anti-saw bar. This configuration increases the strength of the so-called security window between 1000 and 1500%, while reducing the number of parts and labor in the assembly process.

In one embodiment, the blade holder bar is heated in a hot water bath at a sufficient time at or above a certain temperature until a proper expansion that allows said Chromoly bar from being aligned with the fixed position until it cools and contracts, consolidating in one piece, a process that increases the tolerance of the blade holder bar, thus increasing the lifetime of the extrusion die. The bar may have been pre-treated chromoly with a layer known as epoxyca (powder coat), which acts as insulation between the blade holder bar and the Chromoly bar and prevents the formation of any corrosion between dissimilar metals. In one embodiment, the shutters remains fixed and in position so that three deformed bars accelerate the efficient assembly.

The manufacture process of glass louvers has a critical impact in the structural alignment direction (during their flow within the oven). This containment results in the glass having what could be compared to the post tensioned effect in concrete. In applying this concept, the longest side slat of the louver is aligned perpendicular to the flow of the furnace, in favor of natural compression and tension of the glass. In addition, this guides the structural polarization in a more cohesive direction, making it harder towards the short side. The orientation of the louvers results in the longer side being aligned perpendicular to the flow of the furnace for stress and natural compression of the lens. The structural polarization makes for a more cohesive and harder short louver side.

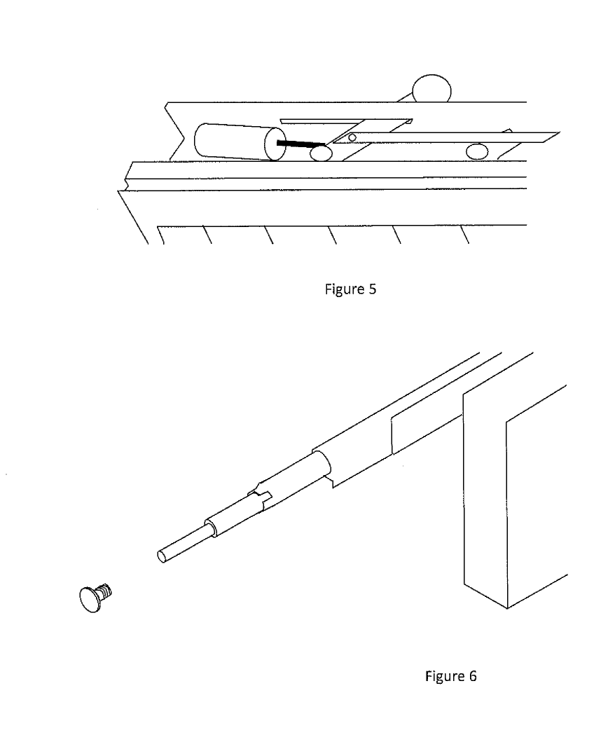

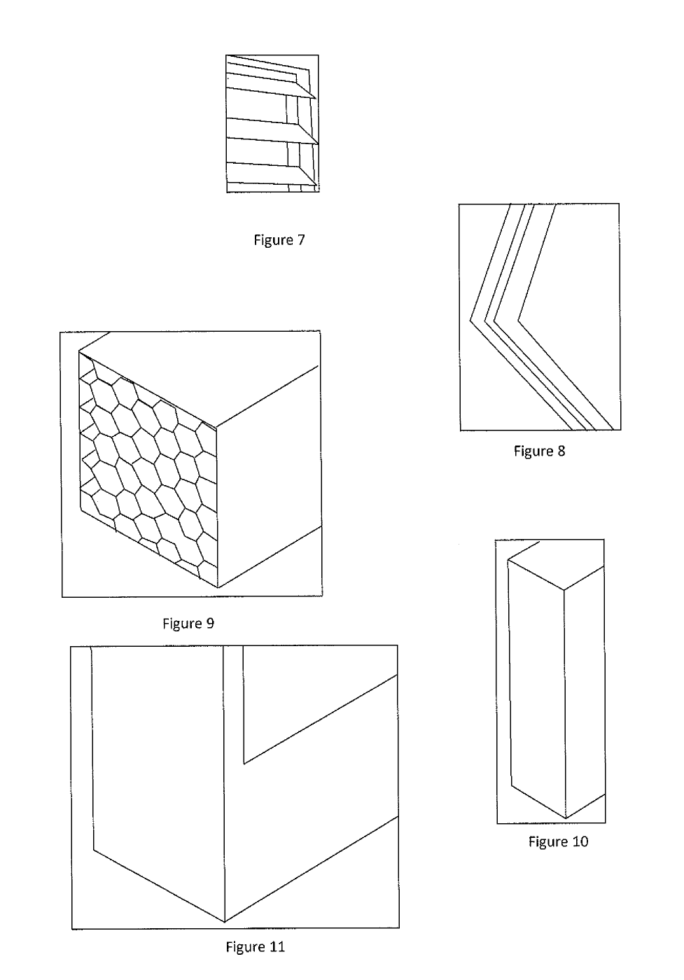

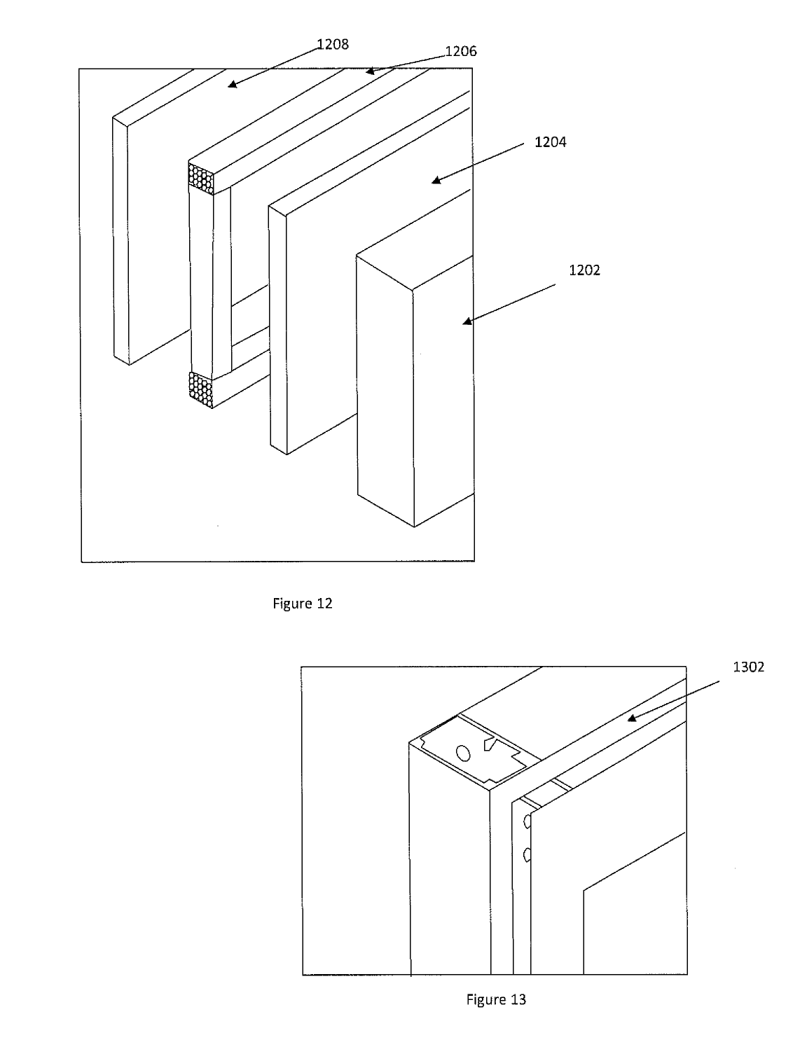

In one embodiment, the simple monobloc rolled glass louver design allows (as seen in FIGS. 7-12) avoiding the traditional need to install laminated glass within a separate non-glass framework that contains it. Said framework creates a problem in energy efficiency, acting as a thermal brake. The thickness of laminated glass is thin in individual layers, making it particularly vulnerable to failure at the edges through breakage or pitting, and increasing the glass thickness compromises the overall weight and increases cost.

In one embodiment, a solution to the above situation is a translucent plastic frame (EDFE) to be applied around the edge and the edge shapes of thermal features, having a groove constrictor that will result in a Monobloc louver laminated glass that may be installed without the need for any additional structure interrupting the thermal conductivity and increasing energy efficiency and resistance to impact. In one embodiment, a band of EDFE may be rolled over the edge of the glass that projects (as an example) 3/32″ on both sides. Then an iron or heating elements is heated and pressed to be fused to the glass edge and sides.

In an alternate embodiment, a thermal honey comb brake is formed from polycarbonate structural cells 0.083 inches big, formed into a 0.5″×0.5″ (and as long as required). Such a configuration makes it rigid while at the same time ductile, so that as a framework for glass or aluminum it will absorb the kinetic energy of the impact, while simultaneously isolate the thermal conductivity and its empty spaces isolate sound within both materials. It is important to note that the material may dyed to reduce or mimic other materials in its visual impact.

The monobloc composite laminated glass louver thus has no visual impact on its frame, is an invisible membrane 1/16″ thick EDFE barely projecting over its edge by a mere 1/16 t1 on both sides to seal and protect it from impacts without interfering with the R factor or thermal resistance (in either heat conduction or convection). As is well known, laminated glass itself already has a (Thermal brake or PVB of R=3%), filters up to 99% UV rays and has multiple glass opacity options.

The proposed honeycomb spacer may be filled to contain argon, krypton or air, making it a structural member and absorbing kinetic energy (from any impact), while acting as thermal and sonic barrier between layers. Such a material would satisfactorily meet regulations U-factor (U.S.IIP), (SHGC)-Solar Heat Gain Coefficient, (VT) Visible Transmittance, (RC) Rating Condensation, resistance to vandalism, hit, explosions, sound, robbery and winds of 200 MPH or more.

In an alternate embodiment, a band of EDFE could be wound around the glass edges into a projected compound 3/32″ on both sides. Then using a heated element be pressed to be fused to glass edges, the brake thermal honey comb and sides. One such embodiment could use a composition of the layers, Interior laminated glass 5/16″ 1202, evguard® foil (R=1.5%) of 3/64″ 1204 and/or laminating+Ab−Ar Eva Pujol® (R=3%) of 3/32″ for structural rigidity; setting on Brake Thermal Honey Comb 1206, with 0.083 cells structures of dimensions 0.5″×0.5″ (and length as required (filled with Argon or Krypton gas and/or air as a heat resistance application). An exterior laminated glass 1208 5/16″with PVB sheet (R=3%) of 3/32 ″thickness (as a kinetic energy sink). All the above could be surrounded by an EDFE translucent plastic 1/16″ thick (to better survive impacts around the edge and/or to forma a seal or anti-delaminating sandwich).

One of the basic principles of fluid mechanics is that energy is not conducted between fluids of different composition within one area without being transmitted to another means so that the kinetic energy received by the first glass sheet at the time of impact is distributed over its surface breaking strain gas pressure dissipates on the surface of the second, doubling or bettering said penetration resistance.

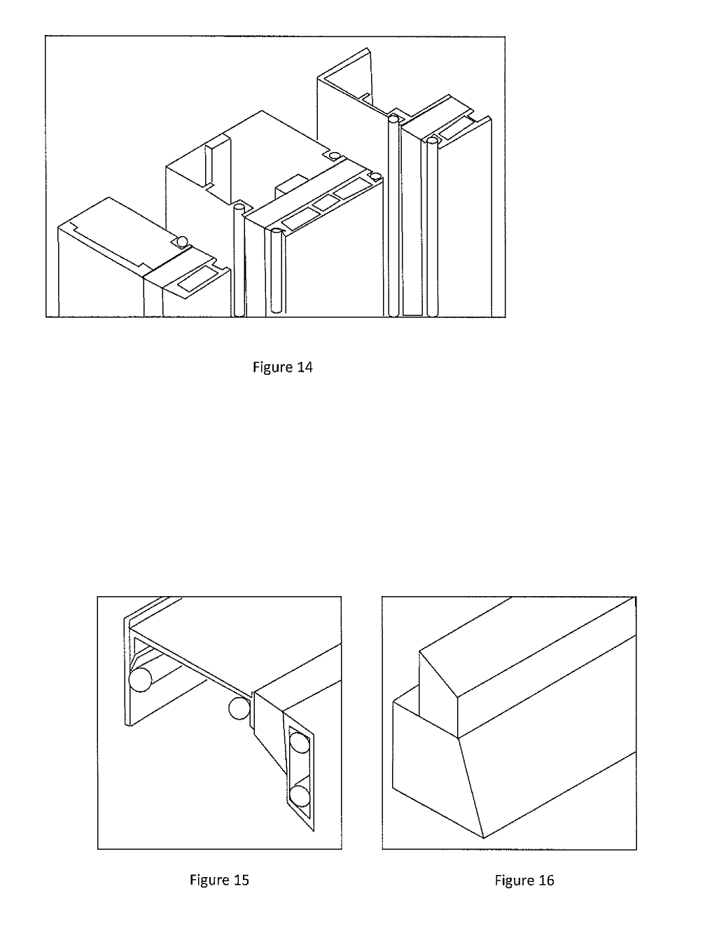

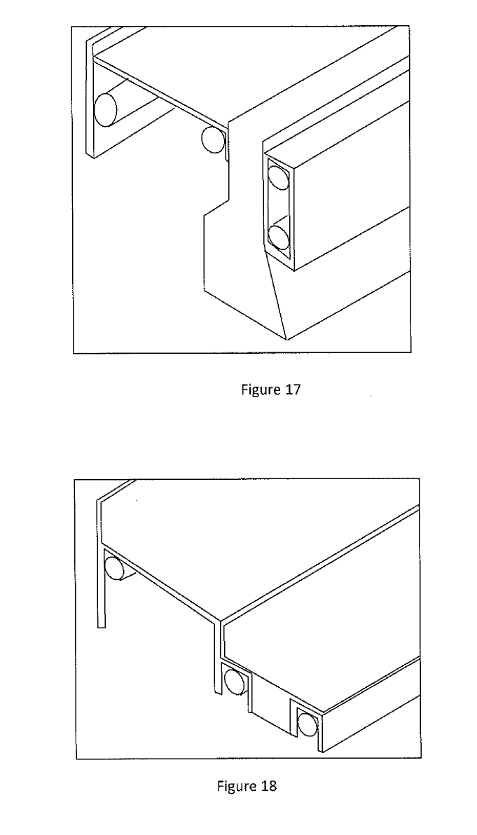

Thus, the thermal honey comb brake (FIGS. 13-18) show sectional illustrations of their use in a top jamb and head 1302. Such a thermal honey comb brake insulates thermal conductivity and sound convection between the outside and inside of the window, door or other structure. This new thermal honey comb brake allows a solid platform reinforced aluminum structure that increases thermal resistance, energy efficiency, climate attributes and sound attenuation performance never before achieved with aluminum.

FIG. 14 illustrates three modes: starting with a (L-R) (top jamb, jamb union windows and no lid). As can be seen the high mind efficient design profiles in different configurations to combine the same element pieces, reducing and increasing its applications. In another embodiment, a sectional head and adjacent slat top seal shows both sides in functional positions, sectional up and seal, jamb seal against louver and louver seal against another louver.

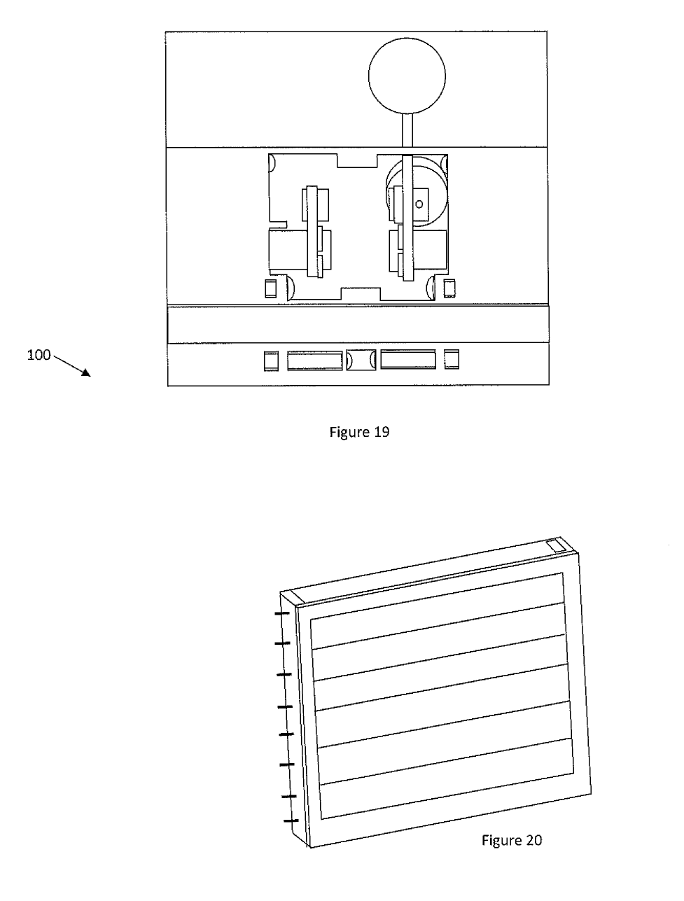

Referring to FIG. 19 we see a sectional illustration of a window bonding system, capable of reinforcing the jambs for the installation of safety bars, anchors and rod affixing system. Such an enjoining system for windows would result in a monolithic structure and a solid and hermetic climate seal to minimize distortion of the jambs in the area of installation of the grab bars and anchors, the design integrates the longitudinal ribs capable of distributing the force of an impact and/or forced opening. The bars of the jambs are projected to reduce the possibility of detachment by deformation (bowing from a force) and have a U-clip that uses rods and washers to secure it. In one embodiment (FIG. 20) we illustrate side anchors creating a super reinforcement that is parallel to the pivot points of the louvers or slats.

In an alternate embodiment, the system may be a solid rock fire escape or egress windows). In such a system, the fire escape system provides an answer to the development of security systems to protect individuals from being trapped in emergencies (such as fires, earthquakes, etc.). In this application, the window is consolidated along a frame by a hinge and one or more locks/bars in its reverse mechanical side, prompting a large contact surface, which provides resistance in terms of impact and/or force. However, in emergencies, it may be released quickly and easily, meeting the dual goals easily.

In one embodiment, the Green Windows shield system is an active protection system comprised of; security bars integrated into the slats (i.e. Chromoly to spacings of 4 in.), super reinforced anchors (parallel to the pivot points of the slats or louvers), monobloc laminated glass, solid rock fire escape (forming an egress windows), Wind resistance to 200 mph winds, Monobloc honey comb impact resistance Monobloc, UV protection factor, SHGC, VT, AL, RC, integrated operator shifter, metal anti-corrosion (both tropical and metropolitan), and almost 100% recyclable.

The above solution will be capable of achieving the following certifications: Anti-theft, Vandalism, Impact Hurricane, Tornado, Explosion and Fire resistance; Energy Star ratings, Sound reduction, ADA, OSHA (for both safety and ergonomics), Glass safety (including ANSI Z97.1_, CPSC 16 CFR 1201 Category II.14)_, Anti-corrosion and up to 99% recyclability .

Additional features may include such add-on as Wireless Smart windows (including interface to Apps), alarms, security cameras, daylight control (using electro chromatic glass). Sound may be reduced through auto reactive acoustic properties, in order to detect undesirable sonic levels (as a default), closing windows blocking the sound depending on physical location (say urban and/or near schools locations), climate control (e.g. rain, wind, etc.), dynamic ventilation control (where windows open and close independently maximizing ventilation and regulating dwelling temperature). In one embodiment, the windows may react in case of fire, temperature and smoke management (whether automatic or under fire department control), to improve the chances of escape and survival. This would potentially improve Green building scores.

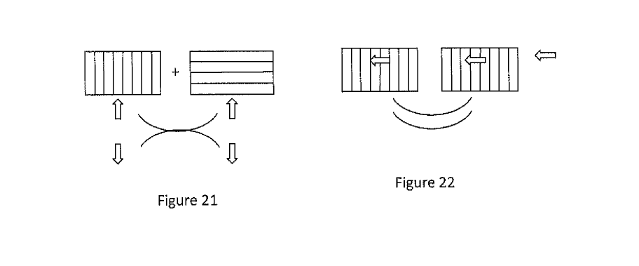

The system may be comprised of the following materials; Titanium oxide crystals (biodegradation of dirt), Electro chromatic glass (regulates transparency), Shielded glassware (to provide bullet or terrorism protection). Referring to FIGS. 21-22, we see how the crystal guidance within the louvers is critical in the manufacture of glass that is resistant to impact. The Pilkington solar-E energy is a high performance range of tinted solar control that offers low heat gain coefficients, reflectivity and emission (also known as Low-E). In another embodiment, the louver glass may have a translucent photovoltaic skin.

The above systems illustrates integrated operator Shifter (be it manual, assisted manual/automatic clutch system), process thermodynamics and shutters, monobloc laminated glass manufacturing process of high impact resistance louvers), Thermal break honey comb (having thermal applications to either conduction or convection) through either structural or sonic barriers; solid rock fire escape egress Windows (resistant to vandalism, impact, explosion, sound, theft and winds.

The system also is envisioned to have windows with auto reactive acoustic properties capable of detecting undesirable sonic levels as a default and reacting by closing windows blocking the sound depending on your location. In addition, in case of fire, smoke or temperature management which would improve the chances of escape and survival.

### CONCLUSION

In concluding the detailed description, it should be noted that it would be obvious to those skilled in the art that many variations and modifications can be made to the preferred embodiment without substantially departing from the principles of the present invention. Also, such variations and modifications are intended to be included herein within the scope of the present invention as set forth in the appended claims. Further, in the claims hereafter, the structures, materials, acts and equivalents of all means or step-plus function elements are intended to include any structure, materials or acts for performing their cited functions.

It should be emphasized that the above-described embodiments of the present invention, particularly any “preferred embodiments” are merely possible examples of the implementations, merely set forth for a clear understanding of the principles of the invention. Any variations and modifications may be made to the above-described embodiments of the invention without departing substantially from the spirit of the principles of the invention. All such modifications and variations are intended to be included herein within the scope of the disclosure and present invention and protected by the following claims.

The present invention has been described in sufficient detail with a certain degree of particularity. The utilities thereof are appreciated by those skilled in the art. It is understood to those skilled in the art that the present disclosure of embodiments has been made by way of examples only and that numerous changes in the arrangement. And combination of parts may be resorted without departing from the spirit and scope of the invention as claimed. Accordingly, the scope of the present invention is defined by the appended claims rather than the forgoing description of embodiments.

1. A window comprising:
a window frame having upper, lower, left and right walls;
a plurality of chromoly bars;
a plurality of louvers extending from the left wall to the right wall of the window frame;
the plurality of louvers being rotatable about a parallel axis;
a drive coupling extending from at least one side of each of the plurality of louvers so as to allow synchronous rotation of the plurality of louvers about the parallel axis;
an operating bar within at least one the left wall or right wall of the window frame, the operating bar being connected with the drive coupling in each of the plurality of louvers; and,
an operator shifter comprising:
a window opening assisting mechanism coupled to the operating bar, said assisting mechanism providing an angular displacement with respect to the operating bar;
a distant holder coupled to the operating bar;
a biasing device having an upper and a lower side, the upper and lower side of the biasing device operatively coupled to the assisting mechanism and the distant holder, respectively; and,
a handle bar operatively coupled to the operating bar.

2. The window of claim 1 wherein the operator shifter further comprises an automatic clutch.

3. The window of claim 1 wherein the plurality of louvers is made of monobloc glass.

4. The window of claim 3 wherein the surface of the plurality of louvers comprises a translucent plastic frame.

5. The window of claim 1 wherein the window frame further comprises a thermal honey comb brake consisting of structural cells.

6. The window of claim 5 wherein the thermal honey comb brake is made of polycarbonate materials.

7. The window of claim 6 wherein the structural cells are filled with gas.

8. The window of claim 1 further comprising reinforced side anchors parallel to the drive coupling extending from at least one side of each of the plurality of louvers.
